(19) United States
(12) Patent Application Publication
(10) Pub. No.: US 2005/0252866 A1
(43) Pub. Date: Nov. 17, 2005

(54) Inline liquid filter with pulsed light sterilization

(76) Inventor: David T. Beckinghausen, Williamsville, NY (US)

Correspondence Address: WILMER CUTLER PICKERING HALE AND DORR LLP, 60 STATE STREET, BOSTON, MA, 02109, US

(21) Appl. No.: 10/965,268

(22) Filed: Oct. 14, 2004

Related U.S. Application Data
(60) Provisional application No. 60/511,057, filed on Oct. 14, 2003.

(51) Int. Cl. B03C 1/00

(52) U.S. Cl. 210/748

(57) ABSTRACT

A compact inline filtering and sterilization system for liquids such as water for residential, commercial, hospital, laboratory, pharmaceutical, and other industrial use utilizes standard media filtration coupled with pulsed white light to sterilize. The unit uses a flow meter at the inlet to detect the flow of the liquid, and directs the untreated liquid first through a filter cartridge, and then through a pathway to be sterilized before exiting the device.

### CROSS-REFERENCE TO RELATED APPLICATION

This application claims priority to Application Ser. No. 60/511,057, filed Oct. 14, 2003, which is incorporated herein by reference.

### BACKGROUND

This invention relates to the field of liquid filtering and deactivating pathogens.

### SUMMARY

A device as described here can be built as a compact inline filtering and sterilization system for liquids such as water for residential, commercial, hospital, laboratory, pharmaceutical, and other industrial use. The unit utilizes standard media filtration coupled with pulsed white light to sterilize. In preferred embodiments, the unit uses a flow meter at the inlet to detect the flow of the liquid, and directs the untreated liquid first through an “off the shelf” filter cartridge, and then directs the liquid through a precise pathway to be sterilized before exiting the device.

The pulsing of intense white light is proven highly effective as an instantaneous sterilization technology to kill bacteria, viruses, spores, molds, fungi, and other microorganisms which either are not trapped by or have grown through a filtration system. Fouling of the flash lamp is minimized by the design of the precise and turbulent liquid pathway, creating a self cleaning effect to the lamp and treatment chamber surfaces. The system can be made in a relatively inexpensive manner. The pulses of white light are created by a flash lamp powered by a capacitor driven generator source which is mounted onto the filtration/treatment chamber body and installed in line to a water system for original construction or as a retrofit. A shut-off valve is provided at both the inlet and outlet to block the flow of the liquid during maintenance and filter replacement. The filter is removable without the need for special tools or detailed instruction. Other features and advantages will become apparent from the following detailed description, drawings, and claims.

The objectives and advantages of this invention are to provide an affordable, compact, highly effective filtration and sterilization device, although some aspects of the invention would not necessarily require that all these advantages be met.

### BRIEF DESCRIPTION OF THE DRAWINGS

FIG. 1 is a partial cross-sectional, partial side view of an embodiment of an inline filtering system.

### DETAILED DESCRIPTION

In one embodiment, a filtration and sterilizing system 10 is mounted in line of a water (or other liquid) source 12 and has three main components: a body 14 that functions essentially as an adapter to the water line 12, a full spectrum pulsed light lamp system 16 removably connected to the body unit; and a filtration housing 18 removably connected to body 14.

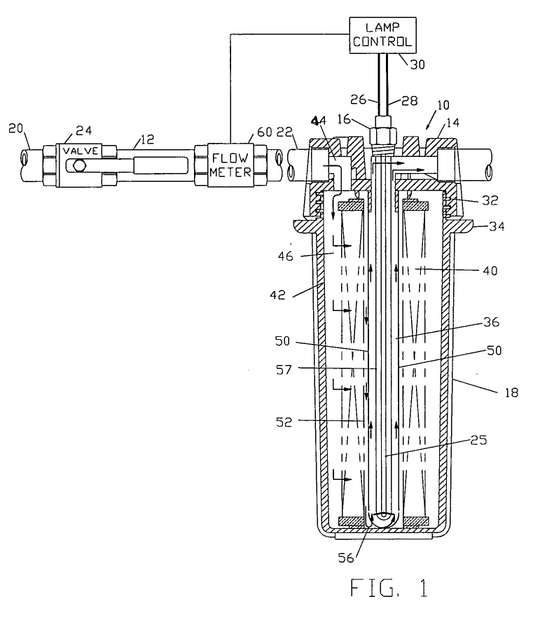

As shown in FIG. 1, body 14 has a water inlet 20 for untreated water and a water outlet 22 for treated water. The inlet and outlet can be co-linear to allow body 14 to be installed in line of a water line, either as part of new construction or as part of a retrofitted addition to an existing water line. A valve 24 can be provided on the inlet side to shut off the water for maintaining the system. Body 14 can be sized appropriately to accommodate different sized water lines.

Full spectrum pulsed light lamp system 16 can be inserted into body 14 in such a manner that it can be removed as desired and needed, but is held rigidly when inserted, e.g., with a threaded compression nut to hold and seal it in place. The lamp 25 has power connections outside of the liquid path providing an intrinsically safe system and ease of maintenance. The lamp preferably only requires power input at one end, although it may be provided at both ends with some modifications, such as an electrical contact at the far end of the device. Lamp 25 is powered by a well defined lamp control and energy generator system 30 that would include a pulsed energy source consisting of capacitors to create high energy, short duration pulses, and timing circuitry for controlling the frequency of the pulses. The lamp is preferably straight and extends along a direction perpendicular to the water line, but it could have any suitable shape.

Filtration unit 18 is removably connected to body 14, preferably with threads 32 and a shoulder 34 that contacts and seals at the body 14. The outer housing 42 of this unit can be formed of polymer or stainless steel and is cylindrical in shape, with a bore defined by a standard size filter cartridge. The inner treatment chamber 52 extending perpendicular to the water line for accepting lamp 25, a protective quartz tube 56 and additional space to define a treatment chamber 36 in which water flows from bottom to top of the treatment chamber. Filtration unit 18 includes an annular filter 40 that can be a ribbon or wound filter and can be carbon-impregnated for removing chlorine and other undesired chemical impurities and particulates from the water.

As shown in FIG. 1, water enters through the water inlet 12 and passes through an L-shaped conduit 44 into an outer annular region 46 between filter 40 and housing 42. The water passes radially inwardly through the filter to an annular region 50 between the filter core 52 and the treatment chamber housing 58 and travels downwardly in the axial direction (upward and downward are used here only for reference, and there is no requirement that it be up or down against gravity). The water passes to a lowermost portion of unit 18 where there are openings 56 in the treatment chamber to allow the water to pass through 36 between the treatment chamber wall 58 and the lamp assembly 25, which would typically have a quartz or glass housing 57 and a xenon flash lamp 25. As the water passes through treatment chamber 58, it is subjected to multiple pulses of full spectrum pulsed white light that will treat and sterilize the water. The inner surface of treatment chamber 57 facing lamp 25 is polished to provide a reflective surface yielding a compound treatment affect with each flash of pulsed light. The treated water then passes back out through water outlet 22 and to the water line. The size of the openings to the treatment chamber and the size of the treatment chamber can be set as desired, but are small enough to insure that the water receives a minimum number of pulses as it passes through the system.

The system is provided with a flow meter 60 which senses the flow of water to instantaneously activate the flash lamp. Lamp control system 30 energizes the lamp to provide pulses. When the flow of water stops, the pulsed light lamp will turn off after a number of additional pulses.

With this system, the water can be filtered and then treated with sterilizing pulses of intense white light before the water is dispensed. As used here, “white light” refers to the fact that the light has far UV, near UV, visible, and infrared components, e.g., 200 nm to 1000 nm. The design is such that the filter cartridges 46 are easily replaced by twisting off the housing 18 from the body 14. A user could remove the filter and clean out the inside of the filtration housing conveniently. Separately, the treatment chamber 57 could be removed and the lamp's protective tube be cleaned or replaced without having to remove the filtration unit out of line.

The size of the filtration unit is preferably on the order of several inches in diameter and about 6-18 inches in length, although larger or smaller sizes can be used, depending on the application. For household type uses, the system can preferably be mounted under a sink.

Appropriate gaskets and seals, such as o-rings, can also be provided. Exemplary parameters include: pulse duration of 1-1000 microseconds measured at ⅓ peak valve; and energy per pulse of 1-2000 J.

Having described embodiments herein, it should be ap0parent that modifications can be made without departing from the scope of the invention as defined by the appended claims. While this description has focused on the household use of water, this can be used for laboratory, pharmaceutical and other industrial liquid applications. While the light source is described as white light and while an exemplary wavelength range is provided, the type of light source and range of wavelengths can vary. Pulsed intense white light is believed useful for deactivating or sterilizing substantially all pathogens. Variations of the spectrum matrix within the lamp output may be used to target a specific or selected pathogen, or to kill or deactivate pathogens to a desired degree or threshold. In short, many of the benefits of the structure may be realized independent of the type of lamp or light that is used. While the lamp system is shown as removably connected to the body/adapter, it could be removably connected to the filter housing.

1. A filtering system comprising:
an adapter for connection to a liquid line and having an inlet for receiving a liquid and an outlet for providing liquid after processing in the filtering system;
a filtration housing holding a filter and removably connected to the adapter to form a filtering assembly; and
a pulsed lamp system including a pulsed light lamp removably connected to the filtering assembly;
the pulsed lamp system providing pulses of light to treat the liquid and the filter for filtering the liquid.

2. The filtering system of claim 1, wherein the filtering housing can be connected to or disconnected from the adapter with a rotating motion.

3. The filtering system of claim 1, wherein the filtering housing is connected to the adapter with a threaded connection.

4. The filtering system of claim 1, wherein the filter has a cylindrical annular shape, and the lamp extends through the filter in a coaxial manner to define an annular region between the lamp and the filter, the liquid flowing through the annular region.

5. The filtering system of claim 1, further comprising a flow meter for sensing the flow of liquid, the sensing of the flow causing the lamp to provide pulses.

6. The filtering system of claim 1, wherein the adapter is constructed to be used to retrofit an existing liquid line.

7. The filtering system of claim 1, wherein the lamp provides pulsed white light suitable for sterilizing water.

8. The filtering system of claim 1, wherein the liquid flows through a defined path under turbulent conditions to create a self cleaning effect on the lamp system.

9. The filtering system of claim 1, wherein the inlet and outlet are oriented to receive and provide liquid in a co-linear manner.

10. The filtering system of claim 1, wherein the lamp is removably connected to the adapter, the lamp being removable without removing the filtering housing.

11. The filtering system of claim 10, wherein the filtering housing is removably connected to the adapter, the filtering housing being removable without removing the lamp assembly.

12. The filtering system of claim 1, wherein the filtering housing is removably connected to the adapter, the filtering housing being removable without removing the lamp assembly.

13. The filtering system of claim 1, wherein the lamp assembly has power connections at one end only.

14. The filtering system of claim 1, wherein the filter is one of a ribbon or wound filter.

15. The filtering system of claim 1, wherein the lamp is generally cylindrical in shape.

16. A method comprising retrofitting an existing liquid line with the filtering system of claim 1.

17. A method of treating liquid comprising:
directing a flow of liquid from a liquid line through an annular filter;
as the liquid is being filtered, providing pulses of light to the liquid to treat the water.

18. The method of claim 17, further comprising sensing a flow of liquid and initiating pulses in response to the sensing.

19. The method of claim 17, wherein an adapter is connected to a liquid line, the filter is in a housing that is removably connected to the adapter without removing the lamp, and wherein the lamp is removably connected to the adapted and is removable without removing the filter housing.
